(19) United States
(12) Patent Application Publication
(10) Pub. No.: US 2026/0355051 A1
(43) Pub. Date: Nov. 12, 2026

(54) INTERACTIVE SEXUAL ENTERTAINMENT AND SEXUAL STIMULATION SYSTEM

(71) Applicant: HYTTO PTE. LTD, Singapore (SG)

(72) Inventors: Dan LIU, Singapore (SG); Renshi YANG, Guangzhou (CN)

(73) Assignee: HYTTO PTE. LTD, Singapore (SG)

(21) Appl. No.: 19/670,675

(22) Filed: May 7, 2026

Related U.S. Application Data
(63) Continuation-in-part of application No. 19/391,093, filed on Nov. 17, 2025, now Pat. No. 12,678,365.

(30) Foreign Application Priority Data
May 9, 2025 (CN) 2025209214654

(51) Int. Cl. A61H 19/00

(52) U.S. Cl. CPC A61H 19/32; A61H 2201/0188; A61H 2201/169; A61H 2201/5012; A61H 2201/5043; A61H 2201/5092

(57) ABSTRACT

A sexual stimulation system is disclosed. The sexual stimulation system includes a housing, a flexible massage portion having a massage channel dimensioned for accommodation of a phallic structure and a light source disposed inside the housing. The housing and the flexible massage portion are configured be at least partially light-transmissive so that at least one corresponding lighting effect exhibited by the light source and at least one of movement of the phallic structure relative to the massage channel and physiological response of the phallic structure are observable from outside of the housing. The light source is configured to exhibit the at least one corresponding lighting effect in response to at least one of the movement of the phallic structure relative to the massage channel and the physiological response of the phallic structure.

### CROSS-REFERENCE TO RELATED APPLICATIONS

This application is a Continuation-in-part of U.S. patent application Ser. No. 19/391,093, filed on Nov. 17, 2025, which claims priority to Chinese Patent Application No. 2025209214654 filed on May 9, 2025, the entire disclosures of which are incorporated herein by reference in their entireties.

### FIELD OF THE INVENTION

The present disclosure relates generally to interactive sexual entertainment and sexual stimulation systems and, more particularly, to sexual stimulation systems incorporating one or more light sources configured to present different lighting effects in response to different monitored information, user interactions, or physiological responses.

### BACKGROUND OF THE INVENTION

Sexual stimulation enhances and maintains sexual arousal, leading to orgasm. Sexual stimulation involves the stimulation of genitals, other body parts, senses, mental stimulation, and the like. Various stimulation devices have been developed to provide sexual stimulation, including devices that simulate tactile sensations through vibration, pressure, rotation, reciprocating motion, and other mechanical means.

In conventional sexual stimulation devices, the primary focus of design and improvement has been directed toward enhancing tactile performance, for example, by refining the material composition of massage portions, increasing the variety and intensity of vibration patterns, or adding supplementary mechanical functions such as suction, thrusting, or rotation. At the present time, however, the sensory experience provided by such devices remains largely limited to the tactile modality. Visual feedback mechanisms, to the extent they exist, are generally static or rudimentary and do not dynamically correspond to the real-time state of use or the physiological condition of the user. This limitation is particularly apparent in scenarios involving remote partner interactions, interactive entertainment platforms, and other multi-user or audience-facing contexts, where the absence of real-time, intuitive visual information reduces the sense of immersion, engagement, and co-presence among participants.

### SUMMARY OF THE INVENTION

A sexual stimulation system includes a housing, a flexible massage portion having a massage channel dimensioned for accommodation of a phallic structure and a light source disposed inside the housing. The housing and the flexible massage portion are configured be at least partially light-transmissive so that at least one corresponding lighting effect exhibited by the light source and at least one of movement of the phallic structure relative to the massage channel and physiological response of the phallic structure are observable from outside of the housing. The light source is configured to exhibit the at least one corresponding lighting effect in response to at least one of the movement of the phallic structure relative to the massage channel and the physiological response of the phallic structure.

The sexual stimulation system may include at least one of a sensor component configured to monitor the movement of the phallic structure relative to the massage channel and a monitoring component configured to monitor the physiological response of the phallic structure.

The sensor component or the monitoring component may be a visual sensor.

The sensor component or the monitoring component may be a low-resolution vision sensor capable of sensing object motion changes without resolving object surface texture.

The light source is disposed at an end portion of the housing.

The light source includes a plurality of light-emitting units circumferentially disposed at the end portion within the housing, the plurality of light-emitting units forming a contour matching a shape of the end portion of the housing.

The light may be arranged in a concealed configuration such that the light source is invisible from an exterior of the housing when the light source is in a non-illuminated state.

The light source may be configured to serve as an indicator light when the sexual stimulation device is in an operating state of sexual stimulation so as to visually display at least one of the movement of the phallic structure relative to the massage channel and the physiological response of the phallic structure. The light source may be configured to serve as an illumination light or an ambient light when the sexual stimulation device is in a non-operating state.

The light source may be configured to exhibit at least two different lighting effects, the at least two different lighting effects differing in at least one of color, brightness, saturation, flashing frequency, lighting mode, illuminated area, number of activated light-emitting units, dynamic trajectory, variation speed and synchronization rhythm.

A brightness of the light source may increase with an increasing of an insertion depth of the phallic structure into the massage channel.

A flashing frequency of the light source may increase with an increase of the thrusting speed of the phallic structure relative to the massage channel.

Color of the light source may vary according to a source of a signal to which the light source responds.

The light source may exhibit a first color in response to the movement of the phallic structure relative to the massage channel, and the light source exhibits at least a second color different from the first color in response to the physiological response of the phallic structure.

The flexible massage portion may be formed and processed from a highly transparent flexible thermoplastic elastomer made from styrene-ethylene-butylene-styrene block copolymer, or formed and processed from transparent-grade thermoplastic polyurethane or addition-type liquid silicone rubber.

A sexual stimulation system includes a flexible massage portion having a massage channel dimensioned for accommodation of a phallic structure, a light source and a sensor. The sensor is configured to monitor at least one of sensing information: changes in parameters related to a volume of the flexible massage portion caused by a movement of the phallic structure relative to the massage channel for monitoring the movement of the phallic member, changes of insertion depth of the phallic structure in the massage channel and physiological response of the phallic structure. The flexible massage portion is configured to be at least partially light-transmissive so that at least one of the movement of the phallic structure and the physiological response of the phallic structure is observable from outside of the flexible massage portion. The light source is configured to exhibit at least one corresponding lighting effect in response to the at least one monitored sensing information.

The at least one corresponding lighting effect may change in real-time in response to changes of the monitored sensing information.

The sensor is a low-resolution vision sensor capable of sensing object motion changes without resolving object surface texture.

An interactive online sexual entertainment system includes an interactive sexual entertainment platform, a sexual stimulation device, at least a terminal and a light source. The interactive sexual entertainment platform is configured to video stream a performance of a user accessible to at least one viewer and provide an online chat room to allow for communication between the at least one viewer and the user. The sexual stimulation device includes a flexible massage portion having a massage channel dimensioned for accommodation of a phallic structure. The terminal is controlled by at least a viewer and is configured for the viewer to input control instructions associated with the sexual stimulation device. The light source is configured to exhibit at least one corresponding lighting effect in response to the control instruction associated with the sexual stimulation device.

The control instruction is an input received from an external control source from the interactive sexual entertainment platform.

The light source may be configured to be structurally independent of the sexual stimulation device to serve as a background light while exhibiting corresponding lighting effect in response to the control instructions associated with the sexual stimulation device.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic illustration of an exemplary sexual stimulation system according to a first embodiment.

FIG. 2 is a schematic illustration of an exemplary sexual stimulation device of the sexual stimulation system according to the first embodiment.

FIG. 3 is a schematic illustration of a sexual stimulation device in an illuminated state.

FIGS. 4A and 4B are schematic diagrams of an exemplary embodiment of the disclosed sexual stimulation device illustrating two different insertion depths of a phallic structure within the massage channel and corresponding different lighting effects exhibited by the light source.

FIG. 5 is a flowchart illustrating an exemplary method of operating the sexual stimulation system.

FIG. 6 is a schematic illustration of an embodiment of the sexual stimulation device, showing a plurality of light-emitting units arranged in circumferentially disposed at an end portion within the housing and arranged in a concealed configuration inside the housing.

FIGS. 7A and 7B are schematic illustrations of an embodiment of the sexual stimulation device server as ambient lights.

FIG. 8 is a schematic illustration of an embodiment of the sexual stimulation device according to a second embodiment.

FIG. 9 is a schematic diagram illustrating an exemplary interactive online sexual entertainment system architecture, showing the sexual stimulation device, an interactive sexual entertainment platform, a user terminal, a server, and one or more viewer terminals, with data flow paths for control instructions.

FIG. 10 is a schematic diagram illustrating an exemplary interactive online entertainment live streaming room.

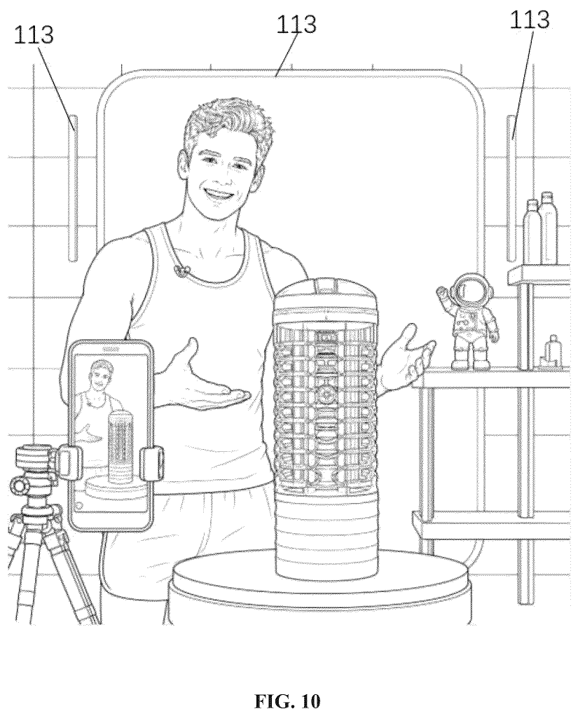

### DETAILED DESCRIPTION OF THE INVENTION

In describing exemplary embodiments of the present disclosure illustrated in the drawings, specific terminology is employed for the sake of clarity. However, the present disclosure is not intended to be limited to the specific terminology so selected, and it is to be understood that each specific element includes all technical equivalents that operate in a similar manner. Furthermore, the following detailed description is illustrative and not restrictive. The scope of the present disclosure is defined by the appended claims, and all changes that come within the meaning and range of equivalents of the claims are intended to be embraced therein.

As used herein, the term “processor” refers to any general-purpose or special-purpose processing circuitry, including but not limited to a central processing unit (CPU), a microcontroller, a microprocessor, a digital signal processor (DSP), a field-programmable gate array (FPGA), an application-specific integrated circuit (ASIC), a system-on-chip (SoC), or any combination thereof. As used herein, the term “memory” or “storage” refers to any non-transitory computer-readable storage medium, including but not limited to random access memory (RAM), read-only memory (ROM), flash memory, solid-state storage, magnetic storage, optical storage, or any combination thereof. As used herein, the term “communication unit” refers to any hardware, firmware, or software component, or combination thereof, configured to transmit and/or receive data via wired or wireless communication protocols, including but not limited to Bluetooth, Bluetooth Low Energy (BLE), Wi-Fi, near-field communication (NFC), Zigbee, cellular (e.g., 4G, 5G), infrared, USB, or any other suitable communication standard. As used herein, the term “light source” refers to any device or component capable of emitting visible light, including but not limited to one or more light-emitting diodes (LEDs), organic light-emitting diodes (OLEDs), micro-LEDs, electroluminescent panels, fiber-optic illuminators, laser diodes, or any combination thereof. As used herein, the term “phallic structure” refers to a penis of a user, a dildo, or any other elongated structure dimensioned for insertion into the massage channel. As used herein, the term “lighting effect” refers to any visually perceptible characteristic or combination of characteristics of light emitted by the light source, including but not limited to color, brightness, saturation, flashing frequency, lighting mode, illuminated area, number of activated light sources, dynamic trajectory, variation speed, synchronization rhythm, or any combination thereof.

### Embodiment 1

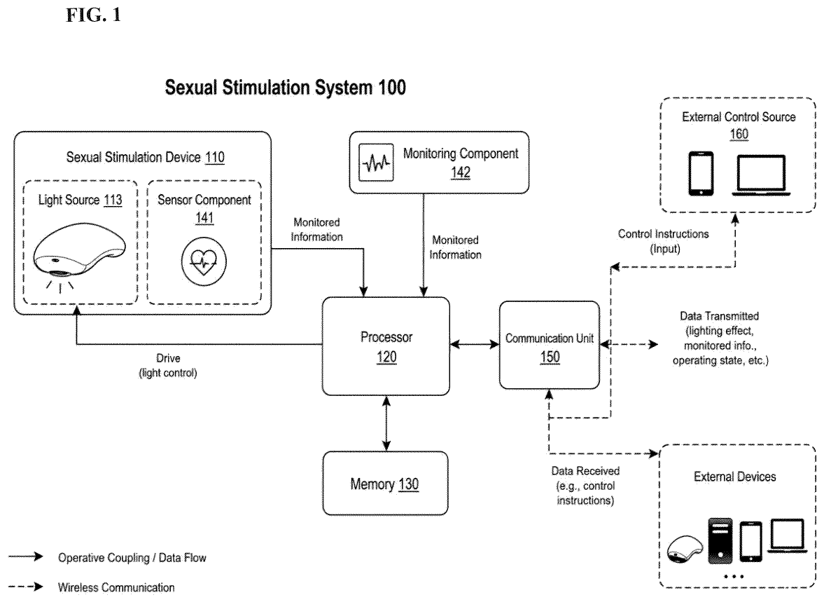

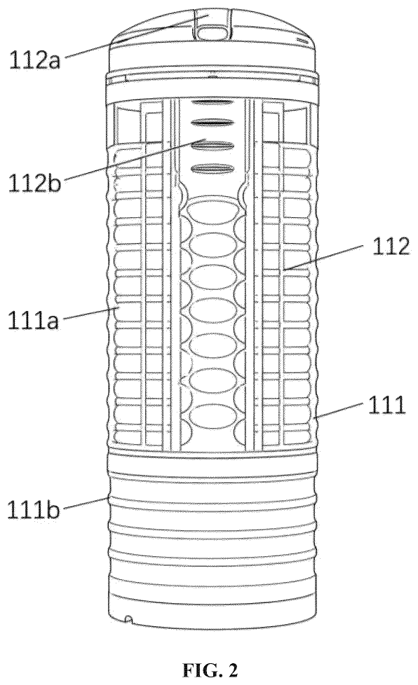

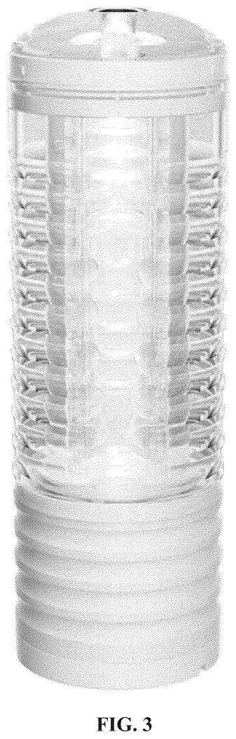

Referring now to FIGS. 1, 2, 3 and 6, an exemplary sexual stimulation system 100 according to a first embodiment of the present disclosure is described. The sexual stimulation system 100 includes a sexual stimulation device 110, and optionally includes one or more of a processor 120, a memory 130, at least one sensor (e.g. at least one sensor component 141, and/or at least one monitoring component 142), a communication unit 150, and an external control source 160.

The sexual stimulation device 110 in this embodiment includes a housing 111, a flexible massage portion 112, and a light source 113. The present disclosure provides a sexual stimulation system that integrates one or more light sources with a sexual stimulation device and the light sources are configured to exhibit dynamically varying lighting effects in response to at least one of movement of a phallic structure relative to a massage channel, physiological response associated with the phallic structure, and an input received from an external control source. The system thereby provides real-time, multi-dimensional visual feedback that enhances immersion, interactivity, and engagement for the user and, optionally, for remote participants or viewers.

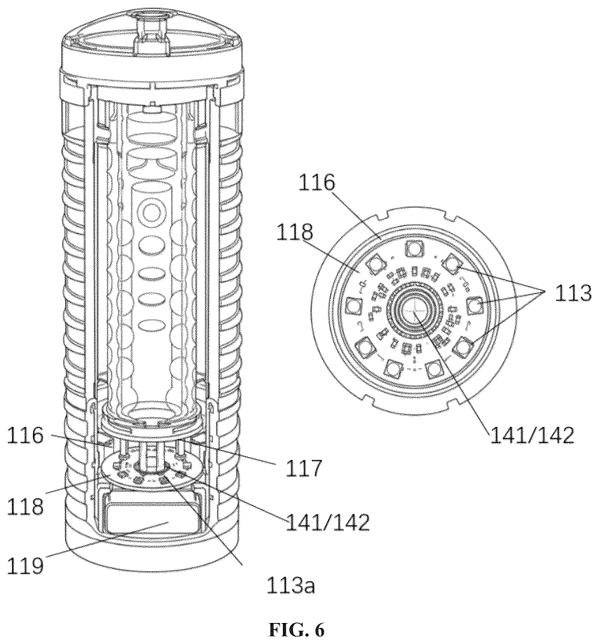

The housing 111 is an elongated, generally cylindrical or ergonomically contoured structure configured to be grasped and held by a user during operation of sexual stimulation. In some embodiments, the housing 111 may be formed from a rigid or semi-rigid material, such as acrylonitrile butadiene styrene (ABS), polycarbonate (PC), or another suitable engineering plastic or glass. Specifically, the housing may be formed and processed from glass, polymethyl methacrylate (PMMA), polystyrene (PS), high impact polystyrene transparent polyvinyl chloride (PVC), polycarbonate, polyethylene terephthalate, transparent polybutylene terephthalate, transparent polypropylene, transparent acrylonitrile butadiene styrene, etc. In some embodiments, the housing is light-transmissive. It is worth emphasizing that the light-transmissive housing structure employed in this embodiment does not mandate the entire housing to be fully light-transmissive or transparent; rather, only a partial region of the housing needs to exhibit light-transmissive or transparent properties. For instance, one end or both opposite ends of the housing may be constructed as non-transmissive or opaque, while the section of the housing overlying the flexible massage portion is specifically designed to be translucent or transparent, allowing light to pass through and be visible from the outside, or the housing includes one or more translucent or transparent windows, apertures, or light-transmitting regions 111a, to allow light emitted by the light source 113 to be visible from outside the housing 111, thereby achieving targeted light transmission while maintaining structural integrity and opaqueness in other regions as desired. Control circuit board 118, power supply 119 and wires are located at bottom of the housing 111 and are blocked by opaque regions of the housing 111, as illustrated in FIG. 6. The left view of FIG. 6 is a view with a partial portion of the housing removed, and the right view of FIG. 6 is a top view of an end portion of the device.

The flexible massage portion 112 is formed from a soft, flexible, body-safe material, such as silicone, thermoplastic elastomer (TPE), liquid silicone rubber (LSR), thermoplastic polyurethane (TPU), or another suitable elastomeric material, or any combination thereof. The flexible massage portion 112 defines a massage channel 112b dimensioned for accommodation of a phallic structure (e.g., a penis of a user of the sexual stimulation device 110). The massage channel 112b has an insertion opening 112a configured for the phallic structure to enter and exit the massage channel 112b. In some embodiments, the interior surface of the massage channel 112b includes one or more textured features, such as ribs, nodules, ridges, bumps, spiral patterns, or undulating surfaces, configured to enhance tactile stimulation. In some embodiments, the structure of the massage channel 112b imitates a female vagina. In other embodiments, the massage channel 112b may imitate other anatomical structures or may have a non-anatomical configuration. Specifically, the flexible massage portion in this embodiment may be formed and processed from a highly transparent TPE made from styrene-ethylene-butylene-styrene (SEBS) block copolymer, or formed and processed from transparent-grade TPU or addition-type LSR, thereby being light-transmissive. With light-transmissive configuration of the housing and the flexible massage portion, movement (i.e., insertion depth, thrusting speed) of the phallic structure relative to the massage channel 112b and physiological response (i.e., erection, ejaculation) of the phallic structure of the user in the massage channel 112b are observable from an outside of the housing 111, thereby providing intuitive, real-time, multi-dimensional visual feedback that enhances immersion, interactivity, and engagement for the user and, optionally, for remote participants or viewers.

Obviously, in conventional live-streaming scenarios, male hosts are generally unable to use a masturbator during streaming because the housing or the flexible massage portion of the device will obscure the penis, preventing viewers from observing it. As a result, in most scenarios, the only option for the host is manually stimulates the penis. This type of streaming lacks entertainment value, because, without the use of such a device, viewers cannot control the sexual interaction between the host and the device, thereby failing to satisfy the viewers' desire for participation or control. The live stream tends to become uninteresting without interactive engagement or rewards. The light-transmissive design of the housing and the flexible massage portion described herein can effectively address the above issues by fully visualizing the sexual interaction between the host and the sexual device, thereby enhancing interaction between the viewers and the host.

In this embodiment, at least a part of the flexible massage portion 112 is disposed in the housing 111. Specifically, a majority of the flexible massage portion 112 is disposed inside the housing 111, and an end of the flexible massage portion 112 where the insertion opening 112a is located extends beyond an end of the housing 111 adjacent to the end of flexible massage portion 112. This configuration prevents the phallic structure from touching the housing 111 when it is inserted into the massage channel 112b, thereby avoiding discomfort to the user. In some embodiments, the insertion opening 112a may protrude from the end of the housing 111 by a distance of, for example, between about 1 mm and about 30 mm, or between about 5 mm and about 20 mm, or about 10 mm to about 15 mm.

Furtherly, the light source is configured to exhibit the at least one corresponding lighting effect in response to at least one of the movement of the phallic structure relative to the massage channel and the physiological response of the phallic structure. In some embodiments, the light source 113 includes one or more light-emitting units such as LEDs 113a. In other embodiments, the light source 113 includes one or more light-emitting units such as OLEDs, micro-LEDs, electroluminescent elements, or fiber-optic illuminators. Specifically, the light source 113 may include a plurality of RGB LEDs or RGBW LEDs, which may be individually addressable, connected in series, or otherwise linked with one another, arranged in an array, a strip, a ring, or another suitable configuration. The light source 113 may be disposed at any suitable location relative to the housing 111 and/or the flexible massage portion 112. For example, the light source 113 may be disposed on an inner surface of the housing 111, on an outer surface of the housing 111, embedded within a wall of the housing 111, disposed between the housing 111 and the flexible massage portion 112, disposed at or near the insertion opening 112a, disposed at or near a closed end of the housing 111 opposite the insertion opening 112a, or at any combination of these locations.

In particular, according to embodiments of the present disclosure, the light source 113 is disposed at an end portion within the housing 111. The light source 113 may be configured to achieve uniform light emission within the housing. To realize such uniform light emission, design considerations may include the arrangement of light-emitting units (e.g., lamp beads, including LEDs) and control of the light emission direction. With respect to the arrangement of lamp beads, a plurality of lamp beads may be annularly disposed at the end portion. For example, a plurality of light-emitting units, such as 6 to 12 low-power LEDs, may be circumferentially arranged at an inner end portion 111b of the housing 111 so as to form a contour conforming to the shape of the housing end portion, as illustrated in FIG. 6. Alternatively, a single high-power LED or a COB light source may be positioned at a central region of the end portion such that light diffuses outward from the center, thereby achieving natural symmetry and uniformity in illumination. Regarding control of the light emission direction, a general objective is to prevent direct impingement of light onto the inner wall of the housing 111; instead, light is configured to undergo diffuse reflection prior to illuminating the housing 111 and the flexible massage portion 112. For instance, the lamp beads may be oriented to emit light laterally along the side walls of the housing, rather than directly irradiating the inner wall surfaces. Specifically, the light-emitting surface of each lamp bead faces a lateral extension direction of the housing 111, instead of directing light radially toward the inner wall. Alternatively, a shallow reflective cup may be arranged to guide light to travel substantially forward, thereby preventing direct light from striking the inner wall and forming bright rings. In this embodiment, a short annular retaining ring 116 is disposed around the lamp beads to block light from directly irradiating on the inner wall to avoid formation of bright edges. An inner wall of the annular retaining ring 116 may be provided with a matte finish or a diffuse reflection layer to enhance the diffuse reflection effect. An additional diffusion sheet 117 may further be disposed in the light emission path of the lamp beads such that light passes through the diffusion layer before illuminating the housing 111 and the flexible massage portion 112, thereby reducing color disparity. Optionally, a light guide rod may also disposed in the light emitting path of the LEDs 113a (e. g, disposed between the LEDs 113a and the diffusion sheet 117) to guide the light of the LEDs 113a to travel along a predefined path. Alternatively, an annular transparent light guide (e.g., formed of PMMA or PC) may be disposed over the LEDs 113a. Optical surface treatments applied to the light guide may include mold texturing, dot patterning, frosting, and fogging.

In some embodiments, the light source 113 is disposed such that light emitted therefrom passes through the light-transmitting region 111a of the housing 111 and the light is visible to an observer external to the device, while the light source 113 itself remains hidden from external view. In this configuration, the light source 113 a may be arranged in a concealed configuration such that the light source is invisible from the exterior of the housing, thereby improving aesthetic appearance of the device. As an optional configuration, a plurality of LEDs 113a may be arranged in an annular array on the inner side of the end portion 111b, which may be configured as an embedded design. For example, an annular groove may be provided at the end portion, and the LED beads may be mounted within the annular groove. Alternatively, the LEDs may be disposed without a groove but shielded by other structurally decorative members having an attractive aesthetically pleasing configuration, such as a decorative ring. As a further alternative, a portion of the housing at a level corresponding to the LEDs 113a may be formed as opaque, as illustrated in FIG. 6. In this manner, the LEDs 113a are shielded by the opaque housing portion and remain substantially invisible from the exterior, while light emitted therefrom is homogenized by the diffusion sheet 117 or the light guide before propagating into the light-transmissive housing to produce a self-luminous visual effect, thereby significantly enhancing the aesthetic quality of the product.

In other embodiments, a circumferential array of LEDs may also be disposed at the other end of the housing, and likewise adopt a concealed configuration. In order to preserve aesthetic appearance, a power supply for supplying power to such LED beads is preferably also concealed when such a configuration is employed, and a compact power supply is suitably adopted.

The lighting effects exhibited by the light source 113 may differ in at least one of the following parameters: color, brightness, saturation, flashing frequency, lighting mode, illuminated area, number of activated light sources, dynamic trajectory, variation speed, or synchronization rhythm. Different colors may correspond to, for example, red, green, blue, yellow, orange, purple, white, warm white, cool white, multi-color, or any other color or combination of colors achievable by the light source 113. Different brightness levels may involve distinctions in light intensity, for example, ranging from a minimum brightness (e.g., off or near-off) to a maximum brightness, with a plurality of intermediate gradations. In some embodiments, the brightness is adjustable across at least 8 discrete levels, or at least 16 discrete levels, or at least 256 discrete levels, or is continuously adjustable. Different saturation levels may include differences in color vividness, ranging from a desaturated or pastel appearance to a fully saturated, vivid appearance. Different flashing frequencies may range from, for example, about 0.1 Hz to about 30 Hz, or about 0.5 Hz to about 15 Hz, or about 1 Hz to about 10 Hz. Different lighting modes may include steady lighting (constant illumination), breathing lighting (gradual increase and decrease in brightness), flashing (rapid on/off cycling), strobing (very rapid on/off cycling), fading (gradual transition between colors or brightness levels), wave lighting (sequential illumination of adjacent light sources to create a wave-like visual effect), rhythmic pulsing (brightness variation synchronized to a rhythm), and the like. Different illuminated areas may involve lighting at different positions along the housing 111 or the flexible massage portion 112, or distinctions between partial lighting (e.g., illumination of only a subset of the light sources) and full lighting (e.g., illumination of all light sources). Different numbers of activated light sources may include activation of a single LED, a subset of LEDs, or all LEDs. Different dynamic trajectories may include flowing lighting (sequential illumination moving in one direction), marquee lighting (sequential illumination moving in a pattern), circular chasing (sequential illumination moving around a circumference), symmetric diffusion (illumination expanding outward from a central point), and the like. Different variation speeds may involve distinctions in fading speed, flowing speed, mode switching speed, color transition speed, and the like. The synchronization rhythm may be a rhythmic pattern that changes synchronously with vibration, thrusting, pressure, sound, music, heartbeat, or remote signals. In some embodiments, the lighting effect is a combination of two or more of the foregoing different lighting effect parameters.

The light source 113 is configured to exhibit a corresponding lighting effect in response to at least one of: (a) the movement of the phallic structure relative to the massage channel 112b; (b) the physiological response of the phallic structure; and (c) an input received from an external control source 160.

Regarding (a), the movement of the phallic structure relative to the massage channel 112b may include one or more of: insertion depth (i.e., how far the phallic structure is inserted into the massage channel 112b), thrusting frequency (i.e., the rate at which the phallic structure is inserted and withdrawn), thrusting rhythm (i.e., the temporal pattern of insertion and withdrawal), thrusting speed (i.e., the velocity of insertion and/or withdrawal), thrusting continuity (i.e., whether the insertion and withdrawal is continuous or includes intermittent pauses), rotational movement, lateral movement, angular movement, thrusting acceleration/deceleration (i.e., the rate at which the thrusting motion increases or decreases in speed over time), thrusting trajectory (i.e., spatial path followed during thrusting motion may be linear, curved, angled, or complex paths, thrusting duty cycle (i.e., the proportion of time of thrusting versus resting or paused), thrusting cycle duration ((i.e., The total time required to complete one full thrusting cycle, including forward motion, return motion, and any paus), pause distribution ((i.e. pauses may occur at fixed intervals, randomly between movements, or consistently at a specific phase such as the end of each forward stroke) or any combination thereof.

In some embodiments, the at least one sensor component 141 includes one or more sensors configured to monitor the movement of the phallic structure relative to the massage channel. As an optional embodiment, the sensor component 141can be a visual sensor. Compared to other sensors such as ultrasonic sensors, LiDAR, pressure sensors, piezoelectric sensors, electromagnetic induction sensors, proximity sensors, etc., a visual monitoring sensor can more intuitively and accurately monitor the movement of the phallic structure. In order to prevent personal privacy leakage, further, the visual sensor may be a low-resolution vision detection sensor capable of sensing object motion changes without resolving object surface texture. For example, may be ultra-low-resolution infrared pixel sensor, optical flow sensor, or event camera. The light-transmissive configuration of the flexible massage portion 112 enables visual sensor to accurately monitor the movement of phallic structure within the flexible massage portion 112. The lighting effect variation of the light source 113 is adjusted based on monitoring data acquired by visual sensor, such that the dynamic light effect changes of the light source 113 can precisely reflect relevant movement information of the phallic structure.

In other embodiments, the sensor component 141 may also be other sensors, such as a pressure sensor array, for example, linearly arranged pressure sensors can be installed on a side wall of the flexible massage portion to monitor the insertion depth and thrust frequency of the phallic structure based on the position or quantity of the pressure sensors touched, as well as the touch frequency.

In other embodiments, the sensor component 141 may also adopt optical sensors, including but not limited to distance measurement optical sensors (e.g., infrared distance sensor, laser distance sensor, time-of-flight (TOF) sensor), position and displacement detection optical sensor (e.g., laser triangulation displacement sensor, position sensitive detector, linear optical grating sensor, rotary optical encoder), and motion trajectory tracking optical sensor (e.g., 2D LiDAR, 3D LiDAR, industrial vision image sensor, optical motion capture sensor).

Alternatively, the sensor component 141 may be a sensor configured to monitor changes in parameters related to a volume of the flexible massage portion caused by the movement of the phallic structure relative to the massage channel, which also provide information or data support for monitoring the movement of the phallic structure. The changes in parameters related to the volume of the flexible massage portion may be changes in a volumetric space formed between the flexible massage portion and the housing based on morphological transformation of the flexible massage portion itself, or may be changes in the volume of the flexible massage portion itself based on morphological transformation of the flexible massage portion, or may be changes in a volume of the flexible massage portion relative to the volume of the phallic member. The sensor component 141 may be an optical sensor component (e.g., an optical scanning sensor or a structured light scanner), a stereoscopic vision sensor component, a liquid level measurement sensor component, a pressure measurement sensor component, a lidar, a millimeter-wave radar, an ultrasonic sensor and/or a stereo camera. For example, sensor component 141 may be an optical sensing component that may be a non-contact tactile device that may obtain data (e.g., three-dimensional data such as dense three-dimensional point cloud data) related to flexible massage portion during a movement of the exemplary disclosed phallic structure through lasers or light spots (e.g., associated with sensor component). Sensor component that may be a stereoscopic vision sensor component may mimic human eyes and capture parallax data related to flexible massage portion (e.g., from different angles using different cameras). Sensor component that may be a liquid level measurement sensor component may obtain relevant information regarding flexible massage portion by measuring a height of a fluid (e.g., liquid) disposed between housing 501 and flexible massage portion. For example, a fluid may be disposed in cavity of housing formed between an interior wall of housing and an exterior of flexible massage portion. Sensor component may be a pressure measurement sensor component may obtain information related to flexible massage portion by measuring a pressure of fluid disposed between an interior wall of housing and an exterior wall of flexible massage portion. The exemplary disclosed fluid may be for example water, gel, a viscous fluid, and/or any other suitable fluid for measuring a height change of the fluid. In some exemplary embodiments, the sexual stimulation device may comprise at least a pressure sensing airbag that may be disposed within the flexible massage portion, and the sensor component may be a pressure sensor that is configured to monitor the changes in the volume of the flexible massage portion itself based on morphological transformation of the flexible massage portion. In some exemplary embodiments, the sensor component may be disposed in the flexible massage portion (e.g., in the massage channel) to monitor changes in a relative volume formed between the flexible massage portion and the phallic member. Sensor component that may be an ultrasonic sensor may obtain information related to flexible massage portion by utilizing ultrasonic waves. The ultrasonic sensor is a compact component that achieves short-range detection by emitting ultrasonic waves and calculating the ultrasonic waves's return time to measure distance.

In at least some exemplary embodiments, the sensor component 141 may be a rotatable optical sensor component such as a rotary laser sensor which may include an optical component and a rotating component configured to drive the optical component to rotate. The optical element may be a laser or an infrared sensor. For example, the exemplary disclosed optical element may be a laser sensor. The exemplary disclosed laser sensor may be a substantially high-precision distance-measuring sensor that may emit a laser with relatively high directionality, single wavelength, and concentrated features (e.g., concentrated ability). The exemplary disclosed laser sensor may thereby achieve substantially ultra-high precision measurement results and may have a relatively fast response speed. For example, if the exemplary disclosed phallic structure moves relatively rapidly inside flexible massage portion, a monitoring result of the exemplary disclosed laser sensor may remain substantially stable and accurate, which may provide substantially accurate monitoring of changes in parameters related to the volume of flexible massage portion. The exemplary disclosed monitoring may facilitate substantially accurate analysis of the movement and changes of the exemplary disclosed phallic member in flexible massage portion. For example, sensor component that may be a rotatable optical sensor component may be a rotary laser scanning radar or a rotary laser sensor. The exemplary disclosed rotary laser scanning radar or rotary laser sensor may provide multi-point distance data (e.g., three-dimensional measurement) to provide three-dimensional scanning and thereby more substantially accurately and reliably monitor (e.g., reflect) changes in the volume of flexible massage portion itself or a volume of flexible massage portion relative to a volume of other components (e.g., as compared to single direction distance sensors such as two-dimensional measurement sensors, which may produce less accurate results than the exemplary disclosed system). In at least some exemplary embodiments, the exemplary disclosed optical sensor component (e.g., laser optical component may include a laser emitter and a laser receiver. For example, laser optical component may include a laser emitter and a laser receiver. In at least some exemplary embodiments, laser optical component including laser emitter and laser receiver may form an infrared laser sensor that operates according to the following steps. Laser emitter may emit a laser beam (e.g., an extremely fine infrared laser beam). Then, rotating scanning may be performed based on laser emitter and laser receiver rotating at a relatively high speed on a same plane, which may allow the generated laser beam to scan the surrounding environment (e.g., 360° scanning such as, for example, similar to a lighthouse emitting light). Then, reflection reception may be performed based on the generated laser beam (by laser emitter) encountering obstacles (e.g., flexible massage portion, housing, and/or other obstacles) and the laser beam may reflect back (e.g., to be received by laser receiver). Then, a distance may be calculated based on laser receiver receiving the reflected light, and a data processing module substantially accurately calculating the distance to the obstacles by calculating the time it takes for the laser to emit from laser emitter and to return to laser receiver. For example, the distance may be calculated using the “time of flight method” in which the distance =(speed of light×time difference)/2, wherein the time difference Δt=t2-t1 (wherein t2 is a time point when the laser returns, and t1 is a time point when the laser is emitted), and Δt is the time it takes for the laser to travel back and forth once. Then, the data processing module may build a map. For example, may combine the distance data of collected data (e.g., many data points each containing angle and distance information) to form a point cloud map of the surrounding environment, which may form a map (e.g., clear map) that may be viewed using the exemplary disclosed user device described herein (e.g., mobile phone or computer).

The exemplary disclosed monitoring method of monitoring changes in parameters related to the exemplary disclosed massage portion may include the following steps. First, static data acquisition may be performed based on the exemplary disclosed system obtaining static three-dimensional data related to the flexible massage portion (e.g., static three-dimensional data of the volume of the vaginal replica itself) in a non-working state (e.g., when the exemplary disclosed phallic member is not inserted in the exemplary disclosed flexible massage portion) using the exemplary disclosed sensor component. The exemplary disclosed data may include static three-dimensional data that may be in the form of multi-frame point clouds. Next, target data acquisition may be performed based on obtaining real-time (e.g., real-time or near real-time) three-dimensional data related to flexible massage portion (e.g., real-time three-dimensional data of the volume of the vaginal replica itself) in a working state (e.g., when the exemplary disclosed phallic member is inserted in the exemplary disclosed flexible massage portion) using sensor component. The exemplary disclosed data processing module may compare the real-time three-dimensional data with the static three-dimensional data described above to determine a target three-dimensional data that has undergone changes (e.g., volume changes). For example, the exemplary disclosed target data acquisition may include obtaining the real-time three-dimensional data related to the flexible massage portion in the working state using sensor component when the exemplary disclosed phallic member is moving in massage channel, comparing each frame point cloud of the real-time three-dimensional data with the static three-dimensional data, and eliminating point clouds that overlap with point clouds of the static three-dimensional data (e.g., remaining point clouds may be determined/retained as the target three-dimensional data). The real-time three-dimensional data may be for example multi-frame point clouds. Next, analysis may be performed based on the target three-dimensional data, including analyzing and obtaining the motion trajectory of flexible massage portion (e.g., a direction or directions in which portions of flexible massage portion move). For example, the analysis may include performing clustering algorithm on the remaining point clouds (e.g., remaining points of the point clouds), dividing the remaining point clouds (e.g., points) into multiple independent target groups, and analyzing the motion trajectory of the target groups to obtain the motion trajectory of flexible massage portion (namely obtain the motion trajectory of the vaginal replica). In some exemplary embodiments, three-dimensional data related to the flexible massage portion may be three-dimensional data related to a relative volume formed between the flexible massage portion (e.g., a vaginal replica) and the housing, or three-dimensional data related to the flexible massage portion may be three-dimensional data related to a relative volume formed between the flexible massage portion (e.g., a vaginal replica) and the genital portion (e.g., a penis or a dildo).

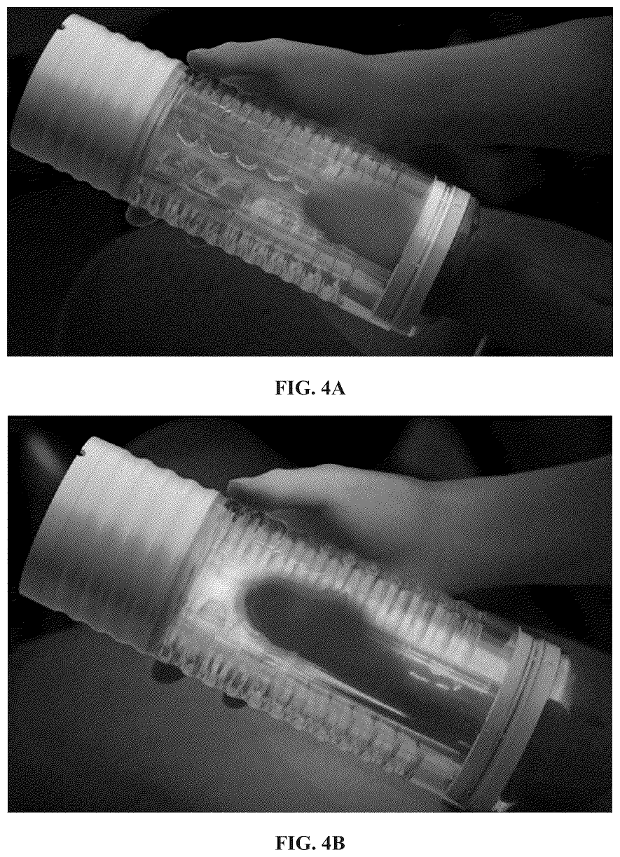

In at least some exemplary embodiments, the degree of brightness of the light source 113 corresponds to the insertion depth of the phallic structure. For example, referring to FIGS. 4A and 4B, the brightness of the light source 113 may increase with increasing insertion depth of the phallic structure into the massage channel 112b. As shown in FIG. 4A, when the phallic structure is inserted to a relatively shallow depth, the light source 113 exhibits a first lighting effect having a lower degree of brightness (e.g., a light red glow). As shown in FIG. 4B, when the phallic structure is inserted to a relatively deeper depth, the light source 113 exhibits a second lighting effect having a higher degree of brightness (e.g., a dark red or intense red glow). In some embodiments, the relationship between insertion depth and brightness may be linear. In other embodiments, the relationship may be non-linear, for example, logarithmic, exponential, sigmoidal, or step-wise.

In at least some exemplary embodiments, the flashing frequency of the light source 113 may correspond to the thrusting frequency of the phallic structure relative to the massage channel 112b. For example, the flashing frequency of the light source 113 may increase with increasing thrusting speed (i.e., thrusting frequency) of the phallic structure. In some embodiments, the flashing frequency is directly proportional to the thrusting frequency. In other embodiments, the flashing frequency is a multiple or fraction of the thrusting frequency.

In at least some exemplary embodiments, the lighting effect corresponds to a combination of the insertion depth and the thrusting frequency. For example, the brightness may correspond to the insertion depth while the flashing frequency simultaneously corresponds to the thrusting frequency, thereby providing a multi-dimensional visual representation of the user's interaction with the device.

In at least some exemplary embodiments, the color of the light source 113 may vary according to the insertion depth, the thrusting frequency, or a combination thereof. For example, a first color (e.g., blue) may correspond to a shallow insertion depth and/or slow thrusting frequency, a second color (e.g., green) may correspond to a moderate insertion depth and/or moderate thrusting frequency, and a third color (e.g., red) may correspond to a deep insertion depth and/or fast thrusting frequency. In some embodiments, the color transitions smoothly across a color spectrum (e.g., from blue through green to red) as the insertion depth and/or thrusting frequency increases.

In at least some exemplary embodiments, the dynamic trajectory of the light source 113 corresponds to the movement of the phallic structure. For example, when the phallic structure is being inserted, a flowing lighting effect may move in a first direction (e.g., from the insertion opening 112a toward the closed end of the housing 111), and when the phallic structure is being withdrawn, the flowing lighting effect may move in a second, opposite direction.

Regarding (b), the physiological response of the phallic structure or of the user may include one or more of: erection state (e.g., degree of tumescence), penile girth or diameter change, pre-ejaculatory fluid presence, ejaculation, or any other physiologically detectable parameter associated with sexual arousal.

In some embodiments, the at least one monitoring component 142 includes one or more sensors configured to detect such physiological responses. As an optional embodiment, the monitoring component 142 may be a visual sensor, more Specifically, a low-resolution vision sensor capable of sensing object motion changes without resolving object surface texture, similar to the example of the sensor component 141 described above. As other optional embodiments, the monitoring component 142 may include a penile plethysmograph, a strain gauge, a pressure sensor, a capacitive sensor, a temperature sensor, a bioimpedance sensor, a photoplethysmography (PPG) sensor, a galvanic skin response (GSR) sensor, a moisture sensor, a gravity analog EMG Sensor, or any combination thereof. In some embodiments, the monitoring component 142 is disposed within the housing 111, within or on the flexible massage portion 112, at or near the insertion opening 112a, or at any other suitable location. In some embodiments, the physiological responses may be indirectly monitored by monitoring component configured to monitor physiological state of the user. The physiological state of the user may include heart rate, blood oxygen saturation, skin temperature, respiratory rate, blood volume pulse, etc. the monitoring component may be heart rate sensor, oxygen saturation sensor (SpO₂ sensor), skin temperature sensor, respiratory rate sensor, or blood volume pulse sensor (BVP sensor)/photoplethysmography sensor (PPG sensor). Furthermore, multiple monitoring functions or targets can also be integrated into one sensor, for example, a photoelectric heart rate and blood oxygen sensor (PPG sensor) can simultaneously detect heart rate, blood oxygen, blood volume pulse, and extract respiratory rate through algorithms. For convenient monitoring, a photoelectric heart rate blood oxygen sensor (PPG sensor) and a digital temperature sensor (for skin temperature monitoring) can be integrated into a separate wearable device worn by the user (e.g., a wristband, a ring, a chest strap and communicates with the sexual stimulation device 110 via the communication unit 150.

In at least some exemplary embodiments, the light source 113 exhibits a first lighting effect (e.g., a calm blue breathing light) when the detected physiological response indicates a low level of sexual arousal, a second lighting effect (e.g., a moderate green pulsing light) when the detected physiological response indicates a moderate level of sexual arousal, and a third lighting effect (e.g., an intense red rapid flashing light) when the detected physiological response indicates a high level of sexual arousal. In some embodiments, the lighting effect transitions smoothly between states as the physiological response changes.

Regarding (c), the input received from the external control source 160 may include one or more of: control instructions from a viewer terminal of an interactive sexual entertainment platform (e.g., a sexual interactive live streaming platform), control signals from a partner's device, control signals from a companion application running on a smartphone, tablet, or computer, or control signals from any other external device or system.

Regarding control instructions from viewer terminals, such instructions may include motivational inputs, such as rewards, tips, donations, virtual gifts, likes, emoji reactions, or other forms of viewer engagement, and/or control commands for the sexual stimulation system 100, such as sending bullet comments or text comments, selections from a menu of available lighting effects or device operating modes, requesting connection, switching viewing angles or camera feeds, controlling sound effects, co-controlling device parameters (e.g., vibration intensity, thrusting speed, lighting effect), voting on device settings, or any other interactive input mechanism provided by the platform.

In some embodiments, the color of the light source 113 may vary according to a source of the signal to which it responds. For example, the light source 113 may exhibit a first color (e.g., red) when responding to movement of the phallic structure, a second color (e.g., green) when responding to a physiological response, and a third color (e.g., blue) when responding to an input from the external control source 160. This color-coding enables an observer (e.g., a remote partner or a live stream viewer) to intuitively distinguish the source of the stimulus that is driving the current lighting effect.

The processor 120 is operatively coupled to the at least one monitoring component 142, and/or to the sensor component 141, and to the light source 113. The processor 120 is configured to receive monitored information from the at least one monitoring component 142 and/or sensor component 141, to determine a corresponding lighting effect based on the monitored information and/or an input from the external control source 160, and to drive the light source 113 to exhibit the determined lighting effect. The memory 130 is operatively coupled to the processor 120 and stores instructions executable by the processor 120 to perform the foregoing operations. The memory 130 may also store one or more lighting effect profiles, mapping tables, algorithms, user preferences, calibration data, or other data used by the processor 120 to determine the appropriate lighting effect.

The communication unit 150 is operatively coupled to the processor 120 and is configured to transmit data to and/or receive data from one or more external devices, such as a user terminal (e.g., a smartphone, tablet, or computer), a partner's sexual stimulation device, a server of an interactive sexual entertainment platform, one or more viewer terminals, or any other external device or system. In some embodiments, the communication unit 150 is configured to transmit information indicative of the current lighting effect, the current monitored information, and/or the current operating state of the sexual stimulation device 110 to an external device, thereby enabling remote visualization, logging, or further processing of such information. In some embodiments, the communication unit 150 is configured to receive control instructions from the external control source 160 and to provide such instructions to the processor 120 for determination of a corresponding lighting effect.

The processor 120 is communicatively coupled to the memory 130, the at least one monitoring component 142, at least one sensor component, the light source 113 (via a light source driver), the communication unit 150, and optionally one or more additional actuators (e.g., to a vibration motor, a thrusting mechanism, an inflation/deflation mechanism, a rotation mechanism, a heating element, or any combination thereof). The light source driver is a circuit or module configured to supply appropriate electrical signals (e.g., pulse-width modulated signals, constant-current signals) to the light source 113 to achieve the desired lighting effect. In some embodiments, the light source drive is integrated with the processor 120. In other embodiments, the light source driver is a separate integrated circuit (IC) or module.

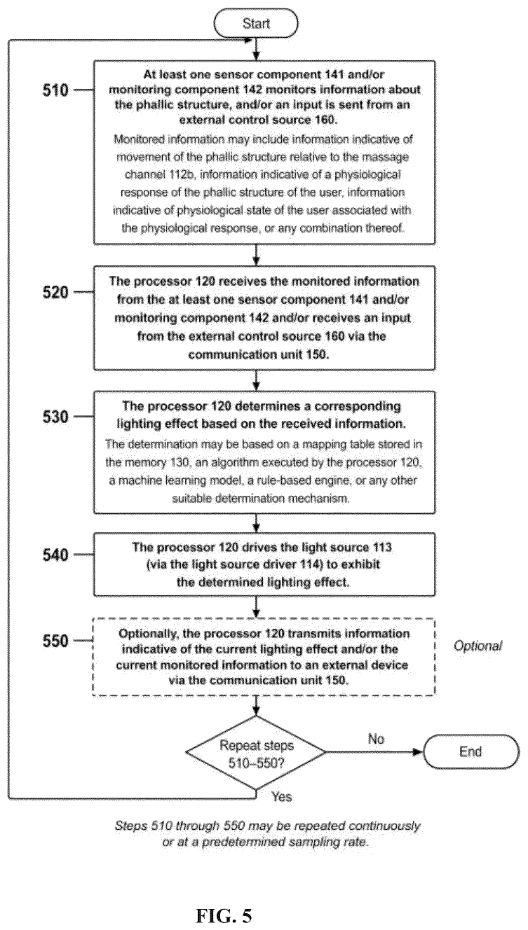

Referring now to FIG. 5, an exemplary method 500 of operating the sexual stimulation system 100 is described. At step 510, the at least one sensor component and/or monitoring component 142 detects information about the phallic member, and/or an input is sent from an external control source 160. The monitored information may include information indicative of movement of the phallic structure relative to the massage channel 112b, information indicative of a physiological response of the phallic structure or of the user, information indicative of physiological state of the user associated with the physiological response, or any combination thereof. At step 520, the processor 120 receives the monitored information from the at least one sensor component 141 and/or monitoring component 142 and/or receives an input from the external control source 160 via the communication unit 150. At step 530, the processor 120 determines a corresponding lighting effect based on the received information. The determination may be based on a mapping table stored in the memory 130, an algorithm executed by the processor 120, a machine learning model, a rule-based engine, or any other suitable determination mechanism. At step 540, the processor 120 drives the light source 113 (via the light source driver) to exhibit the determined lighting effect. At step 550, optionally, the processor 120 transmits information indicative of the current lighting effect and/or the current monitored information to an external device via the communication unit 150. Steps 510 through 550 may be repeated continuously or at a predetermined sampling rate (e.g., at least 10 Hz, or at least 30 Hz, or at least 60 Hz) during operation of the sexual stimulation system 100, thereby providing real-time, dynamic visual feedback.

In some embodiments, the sexual stimulation device 110 further includes one or more additional actuators. The additional actuators may include a vibration motor configured to apply vibration stimulation to the flexible massage portion 112, a thrusting mechanism configured to produce linear reciprocating motion of the flexible massage portion 112 relative to the housing 111 (simulating a thrust function), an inflation/deflation mechanism configured to inflate and deflate the flexible massage portion 112 (simulating a suction function), a rotation mechanism configured to rotate the flexible massage portion 112 or a portion thereof (providing circumferential stimulation), a heating element configured to heat the flexible massage portion 112 to a temperature approximating body temperature, or any combination thereof. In some embodiments, the lighting effect exhibited by the light source 113 is synchronized with the operation of one or more of the additional actuators. For example, the synchronization rhythm of the light source 113 may correspond to the vibration pattern of the vibration motor, the thrusting pattern of the thrusting mechanism, or the inflation/deflation cycle of the inflation/deflation mechanism.

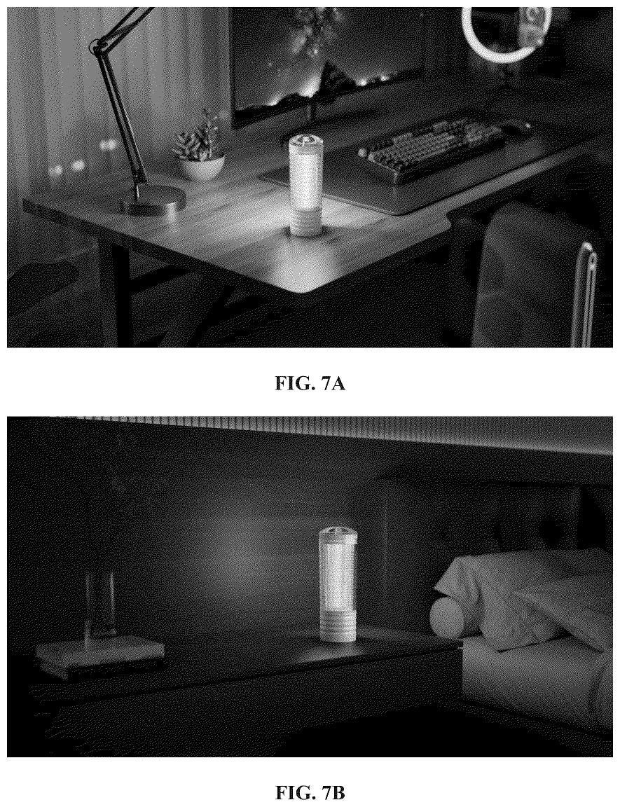

According to embodiments of the present disclosure, the light source may function as an indicator light when the device is in an operating state of sexual stimulation, so as to visually indicate movement or physiological responses of the phallic structure within the flexible massage passage and/or visually reflect an input received from an external control source. When the device is in a non-operating state of sexual stimulation, the light source may serve as an illumination light or an ambient light, as illustrated in FIG. 7A and FIG. 7B. For example, during a stimulation operation, the light source may change in brightness, color, flashing frequency, or lighting mode in synchronization with reciprocating movement, rotational movement, or any other movement between the massage channel and the phallic structure, or physiological responses of the phallic structure within the massage channel, thereby enabling a user to intuitively recognize movement or physiological responses of the phallic structure in real time. When an operation instruction, a mode adjustment, a gear adjustment, or a motivational input is received from the external control source, the light source may correspondingly emit light of a different color, generate a sequential lighting effect, or produce certain flashing pattern, so as to visually feedback a received control instruction, a selected operation mode, an intensity level, or an input state of the external control source. When the device is in a non-operating state, such as standby state or a rest state, the light source may be configured to emit soft, uniform light to provide auxiliary illumination, or to generate a gradual color-changing effect, a breathing lighting effect, or a static ambient lighting effect, thereby enhancing user experience and aesthetic appearance of the device when not in active use.

### Embodiment 2

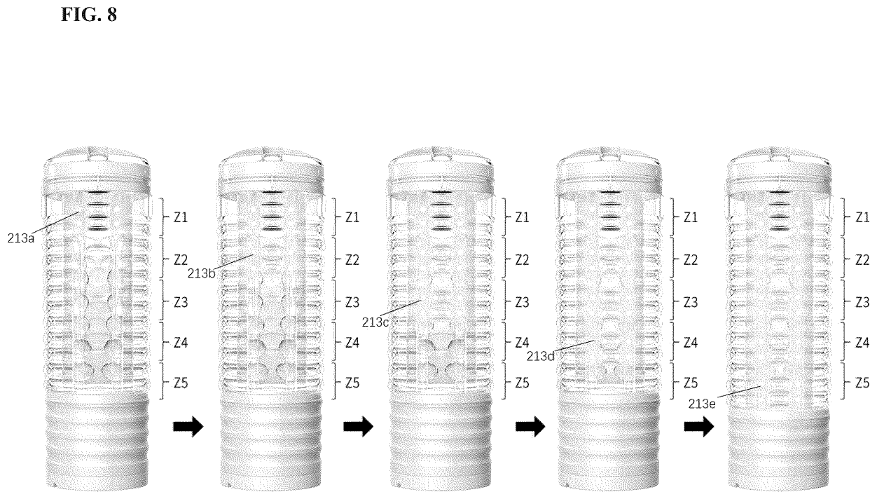

Referring now to FIG. 8, a second embodiment of the sexual stimulation device 210 is described. The sexual stimulation device 210 is similar to the sexual stimulation device 110 of Embodiment 1, and like reference numerals in the 200 series generally correspond to like elements previously described with reference numerals in the 100 series, except as described below. In this embodiment, the light source 213 includes a plurality of individually addressable light-emitting units (e.g., LEDs) 213a, 213b, 213c, 213d, 213e arranged in a distributed array along a longitudinal axis of the housing 211. The plurality of light-emitting units are grouped into a plurality of illumination zones Z1, Z2, Z3, Z4, Z5, each zone corresponding to a different longitudinal position along the massage channel 212b. For example, zone Z1 may be disposed at or near the insertion opening 212a, zone Z5 may be disposed at or near the closed end of the housing 211, and zones Z2, Z3, Z4 may be disposed at intermediate positions therebetween.

In this embodiment, the processor 220 is configured to determine which illumination zones are activated and what lighting effect each activated zone exhibits, based on the monitored information. For example, as the phallic structure is inserted deeper into the massage channel 212b, additional illumination zones are progressively activated. When the phallic structure is inserted to a depth corresponding to zone Z1, only zone Z1 is illuminated. When the phallic structure is inserted to a depth corresponding to zone Z3, zones Z1, Z2, and Z3 are illuminated. When the phallic structure is fully inserted, all zones Z1 through Z5 are illuminated. This progressive illumination provides an intuitive, real-time visual indication of the insertion depth that is immediately perceptible to an observer, such as a remote partner or a live stream viewer.

In some embodiments, each illumination zone exhibits a different color, brightness, or other lighting effect parameter, thereby providing additional visual information. For example, zone Z1 may correspond to the dimmest brightness level, zone Z2 may correspond to a brighter level than Z1, zone Z3 correspond to a brighter level than Z2, zone Z4 correspond to a brighter level than Z3, and zone Z5 may correspond to the brightest brightness level, forming a brightness gradient along the zones. Alternatively, zone Z1 may exhibit a blue light, zone Z2 may exhibit a green light, zone Z3 may exhibit a yellow light, zone Z4 may exhibit an orange light, and zone Z5 may exhibit a red light, creating a color gradient that corresponds to insertion depth.

In some embodiments, the distributed light source array is configured to exhibit dynamic trajectory lighting effects, such as flowing lighting, marquee lighting, or circular chasing, in response to the thrusting motion of the phallic structure. For example, during insertion, the light-emitting units may be sequentially activated from zone Z1 toward zone Z5, and during withdrawal, the light-emitting units may be sequentially deactivated from zone Z5 toward zone Z1, creating a flowing visual effect that tracks the movement of the phallic structure in real time.

In some embodiments, the distributed light source array includes light-emitting units arranged circumferentially around the housing 211 at one or more longitudinal positions, in addition to or instead of the longitudinal arrangement described above. This circumferential arrangement enables circular chasing, symmetric diffusion, and other circumferential dynamic trajectory effects.

### Embodiment 3

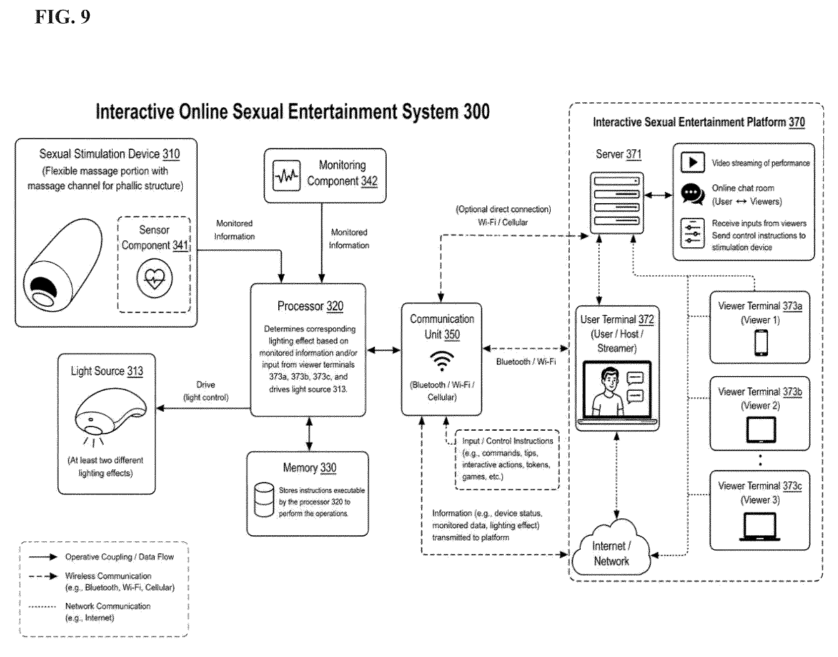

Referring now to FIG. 9 an embodiment of an interactive online sexual entertainment 300 is described. The interactive online sexual entertainment 300 is similar to the sexual stimulation system 100 of Embodiment 1, and like reference numerals in the 300 series generally correspond to like elements previously described with reference numerals in the 100 series, except as described below. In this embodiment, the sexual stimulation system 300 is configured for integration with an interactive sexual entertainment platform 370, such as a sexual interactive live streaming platform.

Referring to FIG. 9, the interactive sexual entertainment platform 370 includes a server 371, a user terminal 372 associated with the user (e.g., a host or streamer) of the sexual stimulation device 310, and one or more viewer terminals 373a, 373b, 373c associated with respective viewers. The sexual stimulation device 310 communicates with the user terminal 372 via the communication unit 350 (e.g., via Bluetooth or Wi-Fi), and the user terminal 372 communicates with the server 371 via a network (e.g., the Internet). The viewer terminals 373a, 373b, 373c communicate with the server 371 via the network. In some embodiments, the sexual stimulation device 310 communicates directly with the server 371 via the communication unit 350 (e.g., via Wi-Fi or cellular connection), without requiring the user terminal 372 as an intermediary.

In this embodiment, the processor 320 is configured to receive inputs from multiple sources simultaneously and to determine a composite lighting effect based on a fusion of the multiple inputs. The multiple sources may include: (i) the at least one sensor component 341 monitoring movement of the phallic structure relative to the massage channel; (ii) at least one monitoring component 342 monitoring physiological responses of the phallic structure; (iii) control instructions from one or more viewer terminals 373a, 373b, 373c received via the server 371 and the communication unit 350; and (iiii) control signals from a partner's device (not shown) received via the communication unit 350.

In some embodiments, the processor 320 applies a priority scheme to the multiple inputs. For example, inputs from the sensor component 341 have a highest priority, inputs from the monitoring component 342 (i.e., real-time physical interaction data) may have a second priority, inputs from a partner's device or from viewer terminals may have a third priority. When inputs from multiple sources are received simultaneously, the processor 320 may blend the corresponding lighting effects (e.g., by averaging color values, summing brightness values, or interleaving flashing patterns), or may select the lighting effect corresponding to the highest-priority input, or may apply any other suitable fusion algorithm.

In some embodiments, the processor 320 is configured to assign different lighting effect parameters to different input sources. For example, the color of the light source 313 may be determined by the category of the input source (e.g., inputs derived from movement of the phallic structure map to a red color scheme, inputs derived from physiological response map to a green color scheme, and inputs derived from viewer inputs map to a blue color scheme). The brightness of the light source 313 may be determined by the physiological response (e.g., higher arousal maps to higher brightness), and the flashing frequency of the light source 313 may be determined by the viewer inputs (e.g., more tips or rewards map to faster flashing). Alternatively, the degree of brightness of the light source may correspond to the insertion depth of the phallic structure (i.e., the brightness of the light source increases with the increasing of the insertion depth of phallic structure into the massage channel), or the flashing frequency of the light may correspond to the insertion frequency of the phallic structure (i.e., the flashing frequency of the light source may increase with the acceleration of the thrusting speed). This multi-parameter, multi-source mapping enables the lighting effect to convey rich, multi-dimensional information simultaneously.

In some embodiments, the interactive sexual entertainment platform 370 is configured to transmit a video feed from a camera associated with the user terminal 372 to the viewer terminals 373a, 373b, 373c, and the video feed includes a view of the sexual stimulation device 310 and its lighting effects. The viewers can thereby observe the lighting effects in real time and can send control instructions to influence the lighting effects and/or other operating parameters of the sexual stimulation device 310. This bidirectional interaction enhances the engagement and entertainment value of the live stream.

In some embodiments, the light source 313 may be disposed inside the sexual stimulation device 310. In some embodiments, the light source 313 and the sexual stimulation device 310 are configured as physically separate components, while optionally in signal communication with each other, and the light source 313 is arranged to serve as a background light in a live streaming scenario. Namely, the light source in this embodiment may be configured to be structurally independent of the sexual stimulation device. The light source in this embodiment may also be configured to respond to the movement of the phallic structure relative to the massage channel, and/or the physiological response of the penis, and/or to emit corresponding lighting effects through input from an external control source, as described in embodiment 1.

The light source 313 configured to serve as background light may be serve as background ambient lighting in a live broadcast scenario, so as to enhance the visual effect and atmosphere of a live broadcast image, and dynamically respond to information such as a live broadcast state, an external control command, a viewer interaction signal, movement of the phallic structure, physiological responses of the phallic structure, or an audio rhythm, to realize real-time variation of lighting effects.

Specifically, lighting forms applicable to a live broadcast background include an annular LED array, a concealed light strip, a COB surface light source, an RGB ambient light, a contour light, a light guide assembly, and the like. In terms of arrangement, the light source may be disposed in a concealed manner inside a background wall, behind a background panel, or within a support frame, so as to form uniform and soft background lighting effects via diffuse reflection, wall washing illumination, or light guide transmission. A contour light may also be disposed behind a user to outline the user's figure and enhance the layering of the image. The light source may further cooperate with a decorative ring, a light-transmissive panel, or a diffusion structure to form integrated background ambient light, thereby preventing glare caused by direct irradiation of the light source toward the camera lens.

During live broadcasting, the background lighting may respond dynamically to different scenarios. For example, the background lighting may correspondingly change color, brightness, or light-emitting area in response to switching of a live broadcast mode; implement on/off control, gradual change, flashing, or a sequential flowing effect in response to an external control command; synchronously pulse in rhythm with background music or an audio signal in response to an audio input; trigger preset lighting special effects to enhance interactive feedback in response to incentive inputs such as viewer interaction, a reward operation, or a remote command; present corresponding variations in brightness, color switching, flashing frequency variation, or dynamic flowing lighting effects in response to different movement of the phallic structure; or adaptively adjust light color, flashing frequency, or breathing rhythm based on detected physiological parameters including heart rate, pulse, blood flow, and pressure to achieve visual feedback of status. In a standby or non-broadcast state, the background lighting may switch to static ambient light, a breathing lighting effect, or low-brightness illumination in a standby or non-broadcast state, thereby achieving both aesthetic appeal and practicality.

In some embodiments, the housing of the sexual stimulation device is opaque with the light source may be set outside the housing or used as a background light source in live streaming scenes. The light source may also be configured to emit corresponding lighting effects in response to the movement of the phallic structure relative to the massage channel, physiological response of the phallic structure, and/or input from an external control source, similar to that described in the first embodiment, However, the movement and physiological response of the phallic structure are not directly observable. Although the movement of the phallic structure relative to the flexible massage portion and physiological response of the phallic structure in this embodiment cannot be directly visible, they may still be monitored by sensor component and monitor component similar to those described in the first embodiment, and the light source emits corresponding light effects in real time or near real time in response to monitored information. This could also provide real-time, multi-dimensional visual feedback that enhances interactivity, and engagement for the user and, optionally, for remote participants or viewers despite the phallic structure itself not being directly observable.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

1. A sexual stimulation system comprising:
a housing;
a flexible massage portion having a massage channel dimensioned for accommodation of a phallic structure;
a light source disposed inside the housing;
wherein, the housing and the flexible massage portion are configured be at least partially light-transmissive so that at least one corresponding lighting effect exhibited by the light source and at least one of movement of the phallic structure relative to the massage channel and physiological response of the phallic structure are observable from outside of the housing, and
wherein the light source is configured to exhibit the at least one corresponding lighting effect in response to at least one of the movement of the phallic structure relative to the massage channel and the physiological response of the phallic structure.

2. The sexual stimulation system according to claim 1, wherein the sexual stimulation system includes at least one of a sensor component configured to monitor the movement of the phallic structure relative to the massage channel and a monitoring component configured to monitor the physiological response of the phallic structure.

3. The sexual stimulation system according to claim 2, wherein the sensor component or the monitoring component is a visual sensor.

4. The sexual stimulation system according to claim 2, wherein the sensor component or the monitoring component is a low-resolution vision sensor capable of sensing object motion changes without resolving object surface texture.

5. The sexual stimulation system according to claim 1, wherein the light source is disposed at an end portion of the housing.

6. The sexual stimulation system according to claim 5, wherein the light source includes a plurality of light-emitting units circumferentially disposed at the end portion within the housing, the plurality of light-emitting units forming a contour matching a shape of the end portion of the housing.

7. The sexual stimulation system according to claim 1, wherein the light is arranged in a concealed configuration such that the light source is invisible from an exterior of the housing when the light source is in a non-illuminated state.

8. The sexual stimulation system according to claim 1, wherein the light source is configured to serve as an indicator light when the sexual stimulation device is in an operating state of sexual stimulation so as to visually display at least one of the movement of the phallic structure relative to the massage channel and the physiological response of the phallic structure; and
the light source is configured to serve as an illumination light or an ambient light when the sexual stimulation device is in a non-operating state.

9. The sexual stimulation system according to claim 1, wherein the light source is configured to exhibit at least two different lighting effects, the at least two different lighting effects differing in at least one of color, brightness, saturation, flashing frequency, lighting mode, illuminated area, number of activated light-emitting units, dynamic trajectory, variation speed and synchronization rhythm.

10. The sexual stimulation system according to claim 9, wherein a brightness of the light source increases with an increasing of an insertion depth of the phallic structure into the massage channel.

11. The sexual stimulation system according to claim 9, wherein a flashing frequency of the light source increases with an increase of the thrusting speed of the phallic structure relative to the massage channel.

12. The sexual stimulation system according to claim 9, color of the light source varies according to a source of a signal to which the light source responds.

13. The sexual stimulation system according to claim 1, wherein the light source exhibits a first color in response to the movement of the phallic structure relative to the massage channel, and the light source exhibits at least a second color different from the first color in response to the physiological response of the phallic structure.

14. The sexual stimulation system according to claim 1, wherein the flexible massage portion is formed and processed from a highly transparent flexible thermoplastic elastomer made from styrene-ethylene-butylene-styrene block copolymer, or formed and processed from transparent-grade thermoplastic polyurethane or addition-type liquid silicone rubber.

15. A sexual stimulation system, comprising:
a flexible massage portion having a massage channel dimensioned for accommodation of a phallic structure;
a light source;
a sensor configured to monitor at least one of sensing information: changes in parameters related to a volume of the flexible massage portion caused by a movement of the phallic structure relative to the massage channel for monitoring the movement of the phallic member, changes of insertion depth of the phallic structure in the massage channel, and physiological response of the phallic structure;
wherein, the flexible massage portion is configured to be at least partially light-transmissive so that at least one of the movement of the phallic structure and the physiological response of the phallic structure is observable from outside of the flexible massage portion; and
the light source is configured to exhibit at least one corresponding lighting effect in response to the at least one monitored sensing information.

16. The sexual stimulation system according to claim 15, wherein the at least one corresponding lighting effect changes in real-time in response to changes of the monitored sensing information.

17. The sexual stimulation system according to claim 15, wherein the sensor is a low-resolution vision sensor capable of sensing object motion changes without resolving object surface texture.

18. An interactive online sexual entertainment system comprising:
an interactive sexual entertainment platform configured to video stream a performance of a user accessible to at least one viewer, the broadcast platform providing an online chat room to allow for communication between the at least one viewer and the user;
a sexual stimulation device, including a flexible massage portion having a massage channel dimensioned for accommodation of a phallic structure, the flexible massage portion being configured be at least partially light-transmissive so that movement of the phallic structure relative to the massage channel or physiological response of the phallic structure are observable from outside of the flexible massage portion;
at least a terminal, controlled by at least a viewer, is configured for the viewer to input control instructions associated with the sexual stimulation device;
a light source;
wherein the light source is configured to exhibit at least one corresponding lighting effect in response to the control instruction associated with the sexual stimulation device.

19. The interactive online sexual entertainment system according to claim 18, wherein the control instructions is an input received from an external control source from the interactive sexual entertainment platform.

20. The interactive online entertainment system according to claim 18, wherein the light source is configured to be structurally independent of the sexual stimulation device to serve as a background light while exhibiting the at least one corresponding lighting effect in response to the control instructions associated with the sexual stimulation device.
